(19) United States
(12) Patent Application Publication
(10) Pub. No.: US 2017/0193133 A1
(43) Pub. Date: Jul. 6, 2017

(54) METHOD AND DEVICE FOR AUTOMATICALLY ROUTING MULTI-BRANCH CABLE

(71) Applicant: Beijing Institute of Technology, Beijing (CN)

(72) Inventors: Jianhua Liu, Beijing (CN); Xiaoyu Ding, Beijing (CN); Jinbao Xu, Beijing (CN); Shaoli Liu, Beijing (CN); Naijing Lv, Beijing (CN); Jiangtao Ma, Beijing (CN)

(73) Assignee: Beijing Institute of Technology, Beijing (CN)

(21) Appl. No.: 15/283,280

(22) Filed: Sep. 30, 2016

(30) Foreign Application Priority Data
Dec. 31, 2015 (CN) 201511029218.0

(51) Int. Cl. G06F 17/50; G06F 17/18

(52) U.S. Cl. CPC G06F 17/50; G06F 17/18

(57) ABSTRACT

The present disclosure provides a method and a device for automatically routing a multi-branch cable, so as to optimize branch points, thereby to acquire an optimal routing scheme and improve the routing efficiency. The method includes the steps of: acquiring position information about connection terminals of the multi-branch cable in a solution space in accordance with a CAD model and a wiring table; determining position information about branch points of the multi-branch cable in the solution space in accordance with the position information about the connection terminals of the multi-branch cable and a first predetermined algorithm; generating a cable routing path map on the surface of obstacle in the solution space in accordance with the position information about the connection terminals of the multi-branch cable, the position information about the branch points and a second predetermined algorithm; and acquiring and outputting a cable model as a routing design result in accordance with the cable routing path map.

### CROSS-REFERENCE TO RELATED APPLICATION

This application claims the benefit and priority of a Chinese Patent Application No. 201511029218.0 filed on Dec. 31, 2015, the contents of which is incorporated herein by reference in the entirety.

### FIELD

The present disclosure relates to the field of multi-branch cable automatic routing technology, in particular to a method and a device for automatically routing a multi-branch cable.

### BACKGROUND

During the research and development of a mechanical and electrical product, a cable routing design, as an important step, mainly relates to determining the lengths and extending directions of cables in the product, as well as positions of slots and hoops. As the mechanical and electrical product becomes more complicated and precise, it requires heavy work in the cable routing design. With the appearance and development of Computer-Aided Design (CAD) technology, the efficiency and quality of the cable routing design have been improved significantly. Currently, the computer-aided cable routing design mainly includes human-machine interactive routing design and automatic routing design. The latter may provide higher routing efficiency due to the use of intelligent computation algorithms.

Although various optimization methods have currently been proposed for the automatic routing design of the multi-branch cable, few engineering constraints are taken into consideration, or merely some feasible positions of the branch points can be acquired, or the positions of the branch points need to be defined in advance. Because the optimization of the branch points is not taken into consideration, it is difficult to acquire an optimal routing scheme. As a result, for the multi-branch cable with a complex structure, it is very difficult to apply these methods to engineering applications due to the low computational efficiency.

### SUMMARY

An object of the present disclosure is to provide a method and a device for automatically routing a multi-branch cable, so as to optimize branch points, thereby to acquire an optimal routing scheme and improve the routing efficiency.

In one aspect, the present disclosure provides in some embodiments a method for automatically routing a multi-branch cable, including steps of: acquiring position information about connection terminals of the multi-branch cable in a solution space in accordance with a CAD model and a wiring table; determining position information about branch points of the multi-branch cable in the solution space in accordance with the position information about the connection terminals of the multi-branch cable and a first predetermined algorithm; generating a cable routing path map on the surface of obstacle in the solution space in accordance with the position information about the connection terminals of the multi-branch cable, the position information about the branch points and a second predetermined algorithm; and acquiring and outputting a cable model as a routing design result in accordance with the cable routing path map.

In one possible embodiment of the present disclosure, the step of determining the position information about the branch points of the multi-branch cable in the solution space in accordance with the position information about the connection terminals of the multi-branch cable and the first predetermined algorithm includes: acquiring a Steiner point in accordance with the position information about the connection terminals of the multi-branch cable and a Steiner Minimal Tree (SMT) algorithm, the Steiner point being such a point as to acquire a shortest connection path for all the connection terminals of the multi-branch cable; acquiring position information about a collision point at the surface of the obstacle closest to the Steiner point in the case that the Steiner point collides with the obstacle; and determining a position of the branch point of the multi-branch cable in the solution space in accordance with the position information about the collision point at the surface of the obstacle.

In one possible embodiment of the present disclosure, the step of generating the cable routing path map on the surface of the obstacle in the solution space in accordance with the position information about the connection terminals of the multi-branch cable, the position information about the branch points and the second predetermined algorithm includes: adding the connection terminals of the multi-branch cable and the branch points as sampling points into a path map in accordance with the position information about the connection terminals of the multi-branch cable and the position information about the branch points; acquiring an initial sampling point in the solution space in accordance with a random sampling algorithm; acquiring position information about a collision point at the surface of the obstacle closest to the initial sampling point in the case that the initial sampling point collides with the obstacle; determining a new sampling point at the surface of the obstacle in the solution space in accordance with the position information about the collision point at the surface of the obstacle; adding the new sampling point into the path map in accordance with the distance between the new sampling point and the point closest to the new sampling point in the path map; acquiring a neighboring node set of the new sampling point in the path map, the neighboring node set being a set of points within a predetermined range from the new sampling point in the path map; and connecting the points in the neighboring node set to the new sampling point to acquire a plurality of edges, and adding the edges not interfering with others into the path map, so as to generate the cable routing path map on the surface of the obstacle in the solution space.

In one possible embodiment of the present disclosure, the step of adding the new sampling point into the path map in accordance with the distance between the new sampling point and the point closest to the new sampling point in the path map includes: in the case that the distance between the new sampling point and the point closest to the new sampling point in the path map is greater than a predetermined threshold, adding the new sampling point into the path map.

In one possible embodiment of the present disclosure, the step of acquiring and outputting the cable model as the routing design result in accordance with the cable routing path map includes: acquiring a shortest path map between the connection terminals of the multi-branch cable and the branch points from the cable routing path map; and fitting the shortest path map to acquire and output the cable model as the routing design result.

In another aspect, the present disclosure provides in some embodiments a device for automatically routing a multi-branch cable, including: an acquisition module configured to acquire position information about connection terminals of the multi-branch cable in a solution space in accordance with a CAD model and a wiring table; a determination module configured to determine position information about branch points of the multi-branch cable in the solution space in accordance with the position information about the connection terminals of the multi-branch cable and a first predetermined algorithm; a generation module configured to generate a cable routing path map on the surface of obstacle in the solution space in accordance with the position information about the connection terminals of the multi-branch cable, the position information about the branch points and a second predetermined algorithm; and a processing module configured to acquire and output a cable model as a routing design result in accordance with the cable routing path map.

In one possible embodiment of the present disclosure, the determination module includes: a first determination sub-module configured to determine a Steiner point in accordance with the position information about the connection terminals of the multi-branch cable and an SMT algorithm, the Steiner point being such a point as to acquire a shortest connection path for all the connection terminals of the multi-branch cable; a first acquisition sub-module configured to acquire position information about a collision point at the surface of the obstacle closest to the Steiner point in the case that the Steiner point collides with the obstacle; and a second determination sub-module configured to determine a position of the branch point of the multi-branch cable in the solution space in accordance with the position information about the collision point at the surface of the obstacle.

In one possible embodiment of the present disclosure, the generation module includes: a first collection sub-module configured to add the connection terminals of the multi-branch cable and the branch points as sampling points into a path map in accordance with the position information about the connection terminals of the multi-branch cable and the position information about the branch points; a second acquisition sub-module configured to acquire an initial sampling point in the solution space in accordance with a random sampling algorithm; a third acquisition sub-module configured to acquire position information about a collision point at the surface of the obstacle closest to the initial sampling point in the case that the initial sampling point collides with the obstacle; a third determination sub-module configured to determine a new sampling point at the surface of the obstacle in the solution space in accordance with the position information about the collision point at the surface of the obstacle; a second collection sub-module configured to add the new sampling point into the path map in accordance with the distance between the new sampling point and the point closest to the new sampling point in the path map; a fourth acquisition sub-module configured to acquire a neighboring node set of the new sampling point in the path map, the neighboring node set being a set of points within a predetermined range from the new sampling point in the path map; and a generation sub-module configured to connect the points in the neighboring node set to the new sampling point to acquire a plurality of edges, and adding the edges not interfering with others into the path map, so as to generate the cable routing path map on the surface of the obstacle in the solution space.

In one possible embodiment of the present disclosure, the second collection sub-module is configured to, in the case that the distance between the new sampling point and the point closest to the new sampling point in the path map is greater than a predetermined threshold, add the new sampling point into the path map.

In one possible embodiment of the present disclosure, the processing module includes: a fifth acquisition sub-module configured to acquire a shortest path map between the connection terminals of the multi-branch cable and the branch points from the cable routing path map; and an output sub-module configured to fit the shortest path map to acquire and output the cable model as the routing design result.

According to the embodiments of the present disclosure, the position information about the connection terminals of the multi-branch cable in the solution space may be acquired in accordance with the CAD model and the wiring table. Next, the position information about the branch points of the multi-branch cable in the solution space may be determined in accordance with the position information about the connection terminals of the multi-branch cable and the first predetermined algorithm. Next, the cable routing path map on the surface of the obstacle in the solution space may be generated in accordance with the position information about the connection terminals of the multi-branch cable, the position information about the branch points and the second predetermined algorithm. Then, the cable model may be acquired and outputted as a routing design result in accordance with the cable routing path map. Through the generation of the cable routing path map on the surface of the obstacle in the solution space in accordance with the first predetermined algorithm and the second predetermined algorithm, it is able to meet the attaching-wall constraint for routing the multi-branch cable, and remarkably improve the computational efficiency and the success rate as compared with the conventional algorithms.

### BRIEF DESCRIPTION OF THE DRAWINGS

FIG. 1 is a flow chart of a method for automatically routing a multi-branch cable according to one embodiment of the present disclosure;

FIG. 2 is a schematic view showing a solution of an STM algorithm in the method for automatically routing the multi-branch cable according to one embodiment of the present disclosure;

FIG. 3 is a schematic view showing the creation of vectors with incremental lengths in the method for automatically routing the multi-branch cable according to one embodiment of the present disclosure;

FIG. 4 is a schematic view showing the determination of branch points in the method for automatically routing the multi-branch cable according to one embodiment of the present disclosure;

FIG. 5 is a schematic view showing PRM path planning;

FIG. 6 is a flow chart of a basic PRM algorithm;

FIG. 7 is a Voronoi diagram of a dispersion degree in the method for automatically routing the multi-branch cable according to one embodiment of the present disclosure;

FIG. 8 is a schematic view showing a Sukharev grid in the method for automatically routing the multi-branch cable according to one embodiment of the present disclosure;

FIG. 9 is a schematic view showing an ideal network partition sampling situation;

FIG. 10 is a schematic view showing a sampling situation based on a Low Dispersion and Obstacle Based Probabilistic Roadmap (LDOB-PRM) algorithm in the method for automatically routing the multi-branch cable according to one embodiment of the present disclosure;

FIG. 11 is a schematic view showing a relationship between success rates and the number of nodes based on different algorithms in the method for automatically routing the multi-branch cable according to one embodiment of the present disclosure;

FIG. 12 is a schematic view showing a cable routing design acquired during product validation according to one embodiment of the present disclosure; and

FIG. 13 is a schematic view showing a device for automatically routing a multi-branch cable according to one embodiment of the present disclosure.

### DETAILED DESCRIPTION OF THE EMBODIMENTS

In order to make the objects, the technical solutions and the advantages of the present disclosure more apparent, the present disclosure will be described hereinafter in a clear and complete manner in conjunction with the drawings and embodiments.

The cable may include a single-piece cable and a multi-branch cable. Usually, the cable used in an engineering environment may be a multi-branch cable containing a plurality of connection terminals. Due to the complex structure of the multi-branch cable, it is necessary to, during the routing design, take not only appropriate branch points but also an entire routing characteristic of the cable and layout constraints desired for the single-piece cable into consideration. Because the branch points of the cable are located at different positions, the topological structure of the cable may vary correspondingly, so do the length, the routing and tying positions of the cable. In the year of 1994, a multi-branch cable automatic routing design was first studied by Conru et al. from Stanford University. To be specific, positions of branch points were determined at first, and then a path was automatically solved using a genetic algorithm, with the path cost for various constraints being taken into consideration. However, the flexibility of the cable and the collisions between the cable and other obstacles in the routing environment were not taken into consideration. In China, Steiner Minimal Tree (SMT) has been used to solve a one-to-many path, and a three-dimensional (3D) Routing System (3DRS) has been developed for an electric machine, which shows the feasibility of the algorithm. However, through this algorithm, it is merely able to find out the feasible positions of the branch points, so it is impossible to ensure the shortest path. In addition, in the related art, a force-directed model and a force-directed algorithm have been proposed to achieve an automobile wire harness connection diagram, so as to automatically search a backbone of the connection diagram and achieve the symmetrical layout of the constraints for the branches of the wire harness, thereby to achieve the automatic layout of the automobile wire harness connection diagram. However, it fails to provide any method for determining the branch points. It has also been proposed in the related art a quick and automatic routing method in a skeleton model. In this method, it is able to automatically complete a 3D routing operation in accordance with a connection relationship between a data table of electrical connector nodes and a 3D model, so as to generate a cable branch diagram and various cable information forms automatically. However, the positions of the branch points (i.e., brackets) need to be defined in advance. In addition, it has also been proposed in the related art a method for automatically routing a multi-branch cable based on an improved Probabilistic Road Map (PRM) algorithm. This method may achieve better routing efficiency and a better success rate, but it is merely able for this method to ensure the feasibility of the branch points as well as a routing sequence of the multi-branch cable.

The present disclosure provides in some embodiments a method and a device for automatically routing a multi-branch cable, so as to optimize branch points, thereby to acquire an optimal routing scheme and improve the routing efficiency.

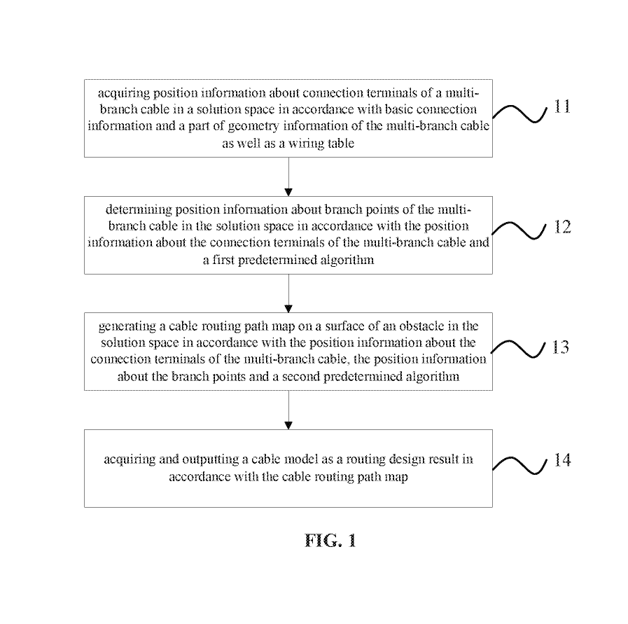

As shown in FIG. 1, in some embodiments of the present disclosure, the method for automatically routing the multi-branch cable includes the following steps.

Step 11: acquiring position information about connection terminals of the multi-branch cable in a solution space in accordance with basic connection information and a part of geometry information of the multi-branch cable as well as a wiring table.

Here, the basic connection information and a part of the geometry information may be acquired in accordance with the wiring table, and then the position information about the connection terminals in the solution space may be acquired in accordance with the basic connection information and geometry information.

Step 12: determining position information about branch points of the multi-branch cable in the solution space in accordance with the position information about the connection terminals of the multi-branch cable and a first predetermined algorithm.

In an alternative embodiment of the present disclosure, the first predetermined algorithm may be an SMT algorithm. A position of a Steiner point may be calculated in accordance with the SMT algorithm, then a position of a collision point may be acquired in the case that the Steiner point collides with the obstacle closest to the Steiner point, and then the position of the collision point may be determined as a position of the branch point.

Step 13: generating a cable routing path map on the surface of obstacle in the solution space in accordance with the position information about the connection terminals of the multi-branch cable, the position information about the branch points and a second predetermined algorithm.

In an alternative embodiment of the present disclosure, the second predetermined algorithm may be an improved LDOB-PRM algorithm which differs, to the greatest content, from the basic PRM algorithm in that a dispersion degree of a sampling point needs to be detected prior to the selection of the sampling point. In this way, it is able to remarkably improve the size of the path map and the computational efficiency. A standard of the dispersion degree may be set, so as to enable the sampling points to be distributed evenly in a sampling space, thereby to prevent the sampling points from being distributed in a too centralized or dispersed manner. Due to the reduction in the number of the nodes in a PRM, it is able to reduce the interference detection times and the connection times, thereby to enable the improved LDOB-PRM algorithm to achieve motion planning in a quicker manner than the basic PRM algorithm.

Step 14: acquiring and outputting a cable model as a routing design result in accordance with the cable routing path map.

To be specific, a shortest path map between the connection terminals of the multi-branch cable and the branch points may be acquired from the cable routing path map, and then the shortest path map may be fitted, so as to acquire and output the cable model as the routing design result.

According to the method for automatically routing the multi-branch cable in the embodiments of the present disclosure, the cable routing path map may be generated on the surface of the obstacle in the solution space, in accordance with the first and second predetermined algorithms. As a result, it is able to meet the attaching-wall constraint for routing the multi-branch cable, and remarkably improve the computational efficiency and the success rate as compared with the conventional algorithms.

Further, Step 12 may include: acquiring a Steiner point in accordance with the position information about the connection terminals of the multi-branch cable and an SMT algorithm, the Steiner point being such a point as to acquire a shortest connection path for all the connection terminals of the multi-branch cable; acquiring position information about a collision point at the surface of the obstacle closest to the Steiner point in the case that the Steiner point collides with the obstacle; and determining a position of the branch point of the multi-branch cable in the solution space in accordance with the position information about the collision point at the surface of the obstacle.

The planning of the multi-branch cable aims to create a shortest obstacle-avoided path connecting all the connection terminals, and as its mathematical essence, it is a Euclidean Steiner Minimal Tree with Obstacle (ESMTO) problem, i.e., a well-known non-deterministic polynomial (NP)-hard problem. Hence, the branch points of the multi-branch cable may be determined by solving the Steiner point.

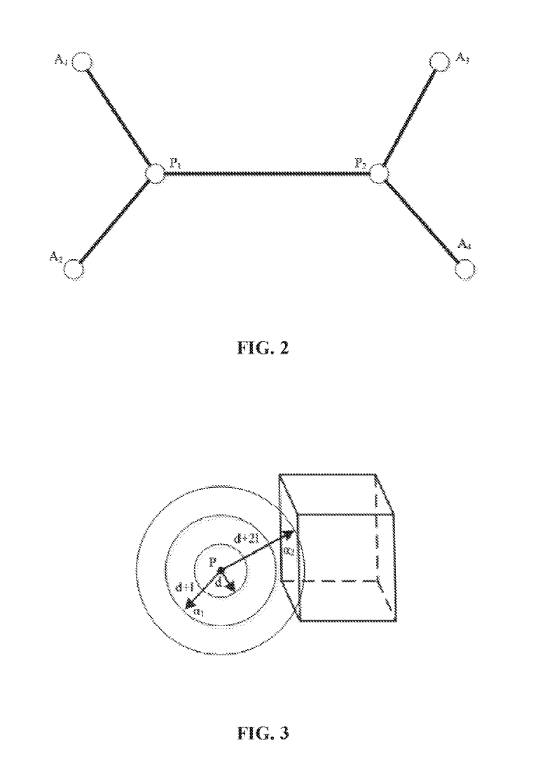

The determination of the branch points of the multi-branch cable includes finding out, in the case of n given points A₁, A₂, . . . , and Aₙ (corresponding to the connection terminals of the multi-branch cable in the embodiments of the present disclosure) in a three-dimensional (3D) space, a point Pᵢ so as to acquire the shortest path connecting all the points, i.e., finding out a minimal tree connecting the n given points, where Pi is the Steiner point. In order to solve the ESMTO problem, a heuristic algorithm is used in the embodiments of the present disclosure to find out the position of the Steiner point. As shown in FIG. 2, a tree with the shortest path connecting all the connection terminals is finally obtained, including vertices V (i.e., A₁, A₂, A₃, A₄, P₁ and P₂), and edges E (i.e., A₁P₁, A₂P₁, P₁P₂, A₃P₂ and A₄P₂).

The Steiner point solved through the above-mentioned method may merely meet a spatial geometry constraint. However, the cable needs to be routed along the surface of the obstacle, so it is required to move the obtained Steiner point to the surface of the obstacle closest to the Steiner point. As shown in FIG. 3, a vector α in an arbitrary direction with P as a starting point and a length of d is created. In the case that the initially-created vector α does not collide with any obstacle in a routing environment, a new vector α in an arbitrary direction with P as a starting point and a length of d+kl (k=0, 1, 2, . . . , 50) may be created, until the vector α (e.g., α₂) collides with an obstacle in the routing environment, where values of d and l are related to the complexity of the routing environment. In an alternative embodiment of the present disclosure, d=50 and l=8. The vector α may be created as follows. An initial vector may be created using three random numbers each within a range of [0, 1], and after the unitization, its coordinate components may be increased by (d+kl) folds, so as to acquire the vector in an arbitrary direction with a desired length. The length of the vector α is gradually increased, so it may certainly collide with the obstacle closest to the point.

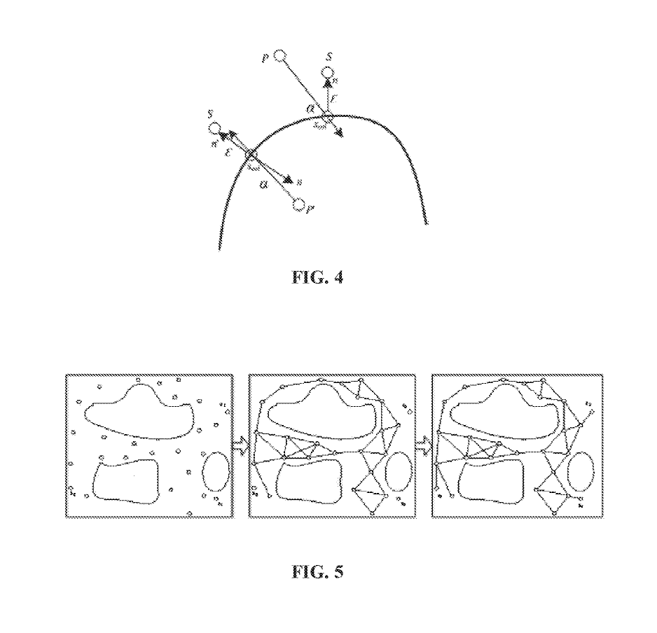

After the vector α collides with the obstacle closest to the point, the relevant collision information, including a collision point s_{col} and a normal vector n of the collision patch, may be calculated, as shown in FIG. 4, where n is perpendicular to the surface of the obstacle. In the case that the obtained Steiner point P is located within the obstacle, e.g., P′ in FIG. 4, the normal vector n may be reversed. The node s_{col} is a point on the surface of the obstacle, and it has collided with the obstacle. At this time, by taking the radius of the cable into consideration, it is required to move the node s_{col} in the direction n by a length ε, so as to acquire a new point S (i.e., the branch point) through the following formula (1):

$$[ \begin{matrix}{x}_{new} \\ {y}_{new} \\ {z}_{new}\end{matrix} ] = [ \begin{matrix}{x}_{col} \\ {y}_{col} \\ {z}_{col}\end{matrix} ] + ɛ [ \begin{matrix}{x}_{n} \\ {y}_{n} \\ {z}_{n}\end{matrix} ] ,$$

where ε represents a step-length constant, which is provided with a value 1.5 times the radius of the cable.

Further, in the embodiments of the present disclosure, Step 13 includes: adding the connection terminals of the multi-branch cable and the branch points as sampling points into a path map in accordance with the position information about the connection terminals of the multi-branch cable and the position information about the branch points; acquiring an initial sampling point in the solution space in accordance with a random sampling algorithm; acquiring position information about a collision point at the surface of the obstacle closest to the initial sampling point in the case that the initial sampling point collides with the obstacle; determining a new sampling point at the surface of the obstacle in the solution space in accordance with the position information about the collision point at the surface of the obstacle; adding the new sampling point into the path map in accordance with the distance between the new sampling point and the point closest to the new sampling point in the path map; acquiring a neighboring node set of the new sampling point in the path map, the neighboring node set being a set of points within a predetermined range from the new sampling point in the path map; and connecting the points in the neighboring node set to the new sampling point to acquire a plurality of edges, and adding the edges not interfering with others into the path map, so as to generate the cable routing path map on the surface of the obstacle in the solution space.

The step of adding the new sampling point into the path map in accordance with the distance between the new sampling point and the point closest to the new sampling point in the path map includes: in the case that the distance between the new sampling point and the point closest to the new sampling point in the path map is greater than a predetermined threshold, adding the new sampling point into the path map.

According to the method for automatically routing the multi-branch cable in the embodiments of the present disclosure, a sampling strategy on the basis of the collision information about the obstacle is adopted, so as to meet an engineering constraint in the case that the cable is routed along the surface of the obstacle. After the acquisition of the branch points, they may be added, together with the connection terminals, into the path map as the initial sampling points, and the shortest routing path connecting these points may be acquired in the solution space. More details will be given hereinafter.

In an alternative embodiment of the present disclosure, a random sampling processing may be performed on the basis of the PRM algorithm. For ease of understanding, the PRM algorithm will be described as follows.

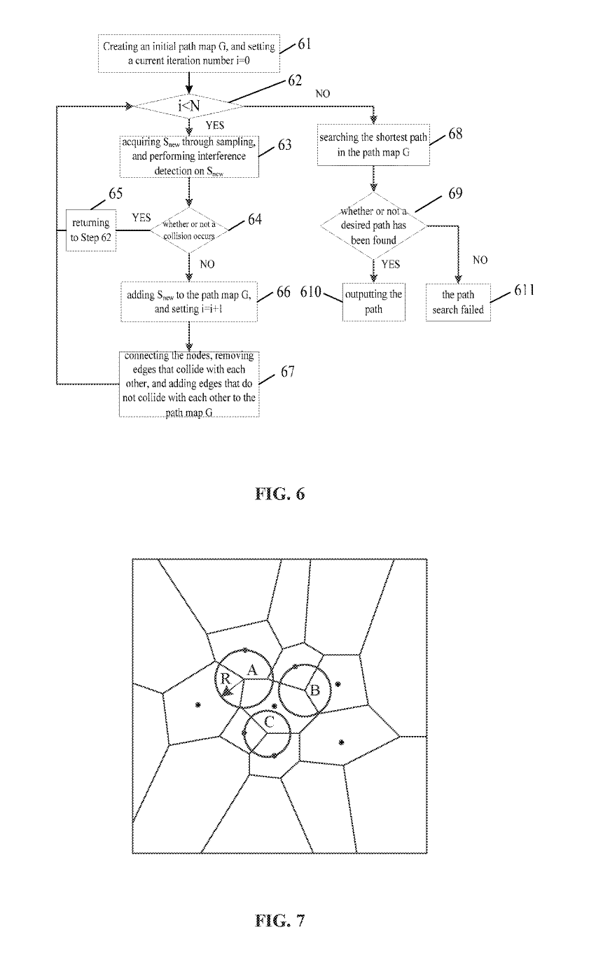

The PRM algorithm, as a quick path planning algorithm, was proposed by Lydia and Jean-Claude Latombe in the year of 1994. It is an algorithm based on sampling and has probability completeness, i.e., in the case of infinite samples, it may certainly find out a feasible collision-free path. An operating process of the basic PRM algorithm includes a learning phase and a query phase. As shown in FIG. 5, in the learning phase, it mainly aims to create a path map G=(V, E) in a solution space. In the query phase, it mainly aims to search for a feasible path connecting the given initial terminals in accordance with the path map created in the learning phase. As shown in FIG. 6, the basic PRM algorithm includes: Step 61 of creating an initial path map G=(V, E) and setting a current iteration number i; Step 62 of determining whether or not i is smaller than a predetermined threshold N; Step 63 of, in the case that i is smaller than N, acquiring S_{new} through sampling, and performing interference detection on S_{new}; Step 64 of determining whether or not a collision occurs; Step 65 of, in the case of the collision, returning to Step 62; Step 66 of, in the case of no collision, adding S_{new} to the path map G, and setting i=i+1; Step 67 of connecting the nodes, removing edges that collide with others, adding edges that do not collide with others to the path map G, and returning to Step 62; Step 68 of, in the case that i is greater than N, searching for the shortest path in the path map G; Step 69 of determining whether or not a desired path has been found; Step 610 of, in the case that the desired path has been found, outputting the path; and Step 611 of, in the case that no desired path has been found, determining that the path search failed.

Due to the random sampling process adopted by the basic PRM algorithm, the acquired sampling points may be distributed irregularly. At this time, the points may not be connected to each other in the path map at some regions (e.g., in a narrow passage), and the path search may fail.

Hence, an improved LDOB-PRM algorithm is adopted in the embodiments of the present disclosure. The multi-branch cable routing path may be acquired through this algorithm, so as to acquire a path map on the surface of the obstacle in the solution space. As a result, it is able to acquire the shortest path for the multi-branch cable from the path map on the surface of the obstacle.

Generally speaking, the sampling points may be selected in such a manner as to make the maximum non-coverage region in the solution space as small as possible. Hence, the random sampling process is introduced in the embodiments of the present disclosure, so as to optimize a performance index called as dispersion degree, and acquire the sampling points at the surface of the obstacle based on the dispersion degree in conjunction with an obstacle-based sampling strategy. Through this mixed sampling strategy, it is able not only to acquire the sampling points at the surface of the obstacle, but also to improve the distribution of the sampling points, i.e., to enable the sampling points to be distributed relatively evenly at the surface of the obstacle in the solution space.

It is known that the solution space is represented by W, and S is a set of the sampling points in the solution space. At this time, the dispersion degree of the finite set S of the sampling points in the solution space W may be calculated using the following formula (2): δ(S,W)=_{w∈W}^{sup}_{s∈S}^{min}ρ(w,s), where ρ represents any geometrical value, e.g., a Euclidean distance. The dispersion degree δ represents a maximum region in the solution space W where no sampling point is contained, i.e., δ corresponds to a radius of a maximum sphere in the solution space where no sampling point is contained. This may be described in a better manner in accordance with a Voronoi diagram. As shown in FIG. 7, each Voronoi vertex is a point where three or more Voronoi regions intersect each other. There is such a circle with each Voronoi vertex as a center that a radius of the circle is equal to a distance between the Voronoi vertex and the closest sampling point. In all these circles, the radius of the maximum circle is just the dispersion degree. This method may also be applicable to a higher dimensional space. Hence, as for the 3D space, the method for solving the dispersion degree just includes finding out the radius of the maximum sphere in the solution space where no sampling point is contained.

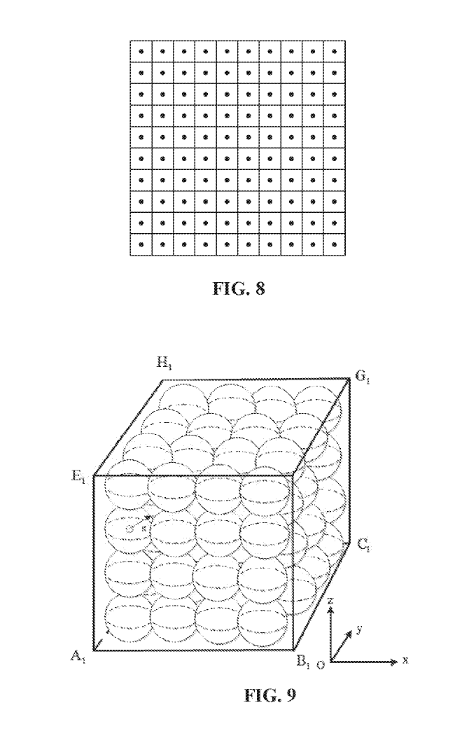

In order to optimize the dispersion degree, the sampling points needs to be distributed more evenly in the solution space, so as to facilitate the path planning. Taking a two-dimensional (2D) space as an example, as shown in FIG. 8, a solution region is divided into 10*10 boxes, and the sampling points are located in the middle of the boxes, so as to achieve the optimal dispersion degree. Actually, as for a grid including k sampling points in an n-dimensional space, the number of the points on each axis is

$$[ {k}^{\frac{1}{n}} ]$$

(the symbol [ ] represents a rounding operation), and such a grid is called as Sukharev grid.

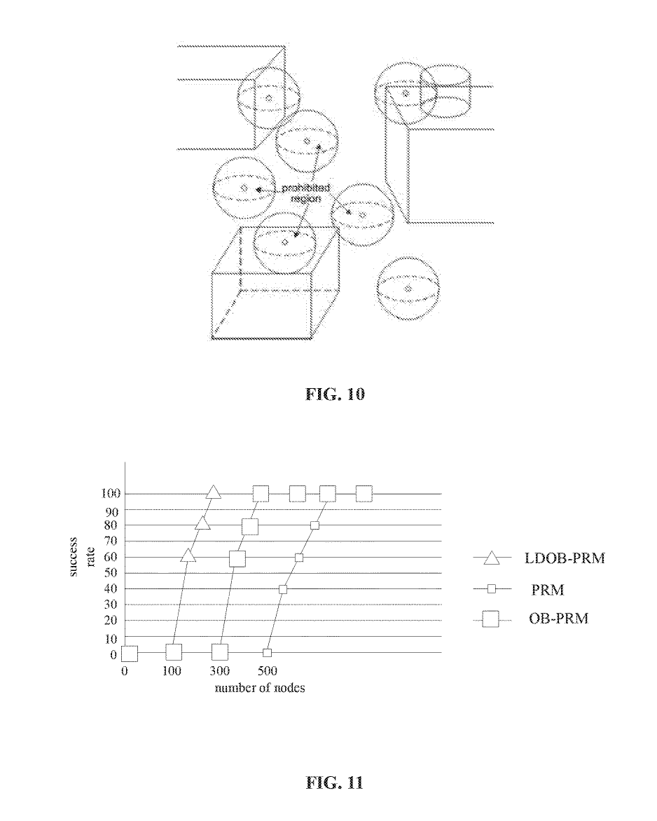

In the case of creating the path map using the basic PRM algorithm, the sampling points S_{rand} are selected randomly, so they may be distributed in the space randomly. Through changing the dispersion degree of the sampling points in the space, it is able for the PRM algorithm to find out the feasible path in the space in the case of fewer sampling points. As a result, it is able to reduce the computation time, and improve the computational efficiency. In the improved PRM algorithm, a prohibited region is defined around each sampling point, and this region may be omitted during the subsequent sampling(s). Hence, a distance between the sampling points needs to be not smaller than a predetermined value R. R may be calculated using the following formula (3):

$$R = \sqrt[3]{\frac{3 ( N - λ ) {V}_{s}}{4 { N}^{2}}} ,$$

where Vₛ represents the size of the solution space, N represents the size of the sampling node, and λ represents a given value. According to the formula (3), in the case that N spherical sub-spaces not overlapping each other are intended to be acquired in the solution space, a total volume of these spherical sub-spaces should be smaller than the size of the solution space. In other words, because some sub-spaces are not contained in the spherical sub-spaces, these sub-spaces that cannot be sampled even in the case that the sampling points are distributed evenly in the space, as shown in FIG. 9.

In each small cube, the sub-space not contained in a spherical sub-space has a volume of R³(24−4π)/3, so the total volume of the sub-spaces not contained in the spherical sub-spaces is NR³(24−4π)/3. Because the total volume of the spherical sub-spaces is smaller than the actual solution space, the following formula (4) may be acquired:

$$N \frac{4}{3} { R}^{3} \leq {V}_{s} .$$

In the case that the parameter λ is introduced, the following formula (5) may be acquired:

$$N \frac{4}{3} { R}^{3} = {V}_{s} - \frac{λ}{N} {V}_{s} .$$

It means that, there are at least λ small cubes where no sampling point is located. At this time, the above formula (3) for calculating R may be acquired. In order to make the formula (3) tenable, λ needs to meet the following formula (6): λ<N.

In this way, after the generation of N sampling points, there is at least one small cube where the N sampling points are located. Obviously, it is very important to select an appropriate value of λ, and the coverage of the algorithm may be affected by the value of λ. Through tests, it is found that a better coverage effect may be acquired in the case of λ=\sqrt{N}.

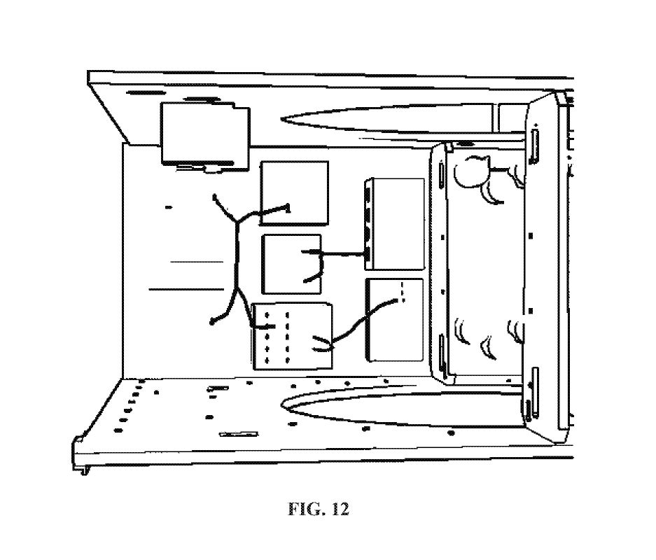

In the embodiments of the present disclosure, the improved PRM algorithm differs, to the greatest extent, from the basic PRM algorithm in that the dispersion degree of the sampling point needs to be detected prior to the selection of the sampling point. In this way, it is able to remarkably improve the size of the path map and the computational efficiency. A standard of the dispersion degree may be set, so as to enable the sampling points to be distributed evenly in a sampling space, thereby to prevent the sampling points from being distributed in a too centralized or dispersed manner. Due to the reduction in the number of the nodes in the PRM, it is able to reduce the interference detection times and the connection times, thereby to enable the improved LDOB-PRM algorithm to achieve motion planning in a quicker manner than the basic PRM algorithm. FIG. 10 shows a sampling process based on the LDOB-PRM algorithm. After a sampling point has been selected, a region contained in a sphere with this sampling point as a center and having a radius of R is a prohibited region, and the subsequent sampling points are not allowed to occur within this prohibited region.

In order to meet the engineering constraint in the case that the cable is routed along the surface of the obstacle, a sampling strategy based on the collision information about the obstacle may be adopted. At first, the sampling point s_{rand} may be acquired through random sampling, and then the new sampling point s_{new} at the surface of the obstacle closest to the sampling point s_{rand} may be acquired using the above-mentioned method. Next, a point sₙₑₐᵣ closest to s_{new} in the path map V and a distance L between these two points may be calculated. In the case that L>R, s_{new} may be added to the path map; otherwise, s_{new} may be discarded, and a next circle may be performed.

After the new sampling point s_{new} has been acquired through the Low Dispersion Obstacle sampling strategy, a set Vₙₑₐᵣ of all the neighboring nodes of the new sampling point in the sampling point set V may be calculated using the following formula (7): Vₙₑₐᵣ={sₙₑₐᵣ∈V|ρ(s_{new},sₙₑₐᵣ)≦D}. According to this formula, the neighboring node set of the sampling point s_{new} may include all points within a spherical space with the sampling point s_{new} as a center and having a radius of D. The success rate of the algorithm and the computational efficiency may be affected by the value of D. In the case that D is of a too small value, the points in the path map cannot be connected to each other, and the path search may fail. In the case that D if of a too large value, the number of the redundant edges in the path map may increase, and the computational cost may increase too. Through tests, it is found that a better effect may be achieved in the case that D if of a value within a range of (2R, 4R), and in the embodiments of the present disclosure, D=3R. After acquiring the neighboring node set, each point in the neighboring node set may be connected to the sampling point s_{new} to form an edge. Then, the interference detection may be performed on all the edges, and the edges that do not interfere with others may be added into the path map, so as to create the cable routing path map.

Upon the creation of the cable routing path map, the shortest path connecting the connection terminals may be searched for from the cable routing path map. Through the above-mentioned method, a series of edges, i.e., path segments, may be acquired during the solution of the branch points, so it is merely required to search for the shortest path for these path segments in the cable routing path map. The PRM algorithm may be used to search for multiple paths, and the created path map may be used repeatedly, until all the path segments have been planned. In the embodiments of the present disclosure, an A* algorithm may be adopted so as to search for the shortest path between two connection terminals in the path map.

A series of path segments obtained through the path search correspond to cable segments of the multi-branch cable. The path consists of a series of discrete points, and it needs to perform smoothing processing on the cable path. At first, the redundant points may be removed, and then a smooth path may be acquired through curve fitting. During the fitting operation, a minimum bending radius for each point in the path may be modified, so as to meet the engineering constraint, thereby to generate the cable routing path map in accordance with the cable harness attribute.

In an alternative embodiment of the present disclosure, a motion planning algorithm based on sampling is adopted. Usually, probability completeness may be used to analyze the performance of the algorithm. The so-called “probability completeness” means that, in the case of infinite samples, it is able for the planning algorithm to certainly find out a feasible collision-free path. In order to illustrate the probability completeness of the LDOB-PRM algorithm, it will be demonstrated hereinafter that the size of the region where no sampling point is located approaches to 0 along with the increase of the number of sampling points. In other words, in the case of sufficient sampling points, it is able for the LDOB-PRM planning algorithm to cover all the solution spaces. As mentioned above, for the LDOB-PRM planning algorithm, the total volume of the sub-spaces may be calculated by the formula (4). As can be seen from the formula (4), after the generation of N sampling points, a total volume of the sub-spaces where no sampling point is located is

$$\frac{λ}{N} {V}_{s} .$$

Through a limit operation on the formula (4), the following formula (8) may be acquired:

$${lim}_{N \to ∞} ( {V}_{s} - \frac{λ}{N} {V}_{s} ) = {V}_{s} = N \frac{4}{3} { R}^{3} .$$

In the case that the size of the solution space is constant, for the given value N, the convergence of the formula completely depends on the value of λ. In addition, a unique limiting condition for the formula (6) lies in that the value of λ needs to be smaller than N. Hence, in the case that N increases, a value of

$$\frac{λ}{N} {V}_{s}$$

gradually approaches to 0. Further, it is also concluded that, in the case of sufficient sampling points, the LDOB-PRM algorithm may cover all the solution space. Meanwhile, in the case that there is a feasible path, it may be found certainly.

Test examples have been provided so as to, as compared with the basic PRM algorithm and an OB-PRM algorithm, validate the computational efficiency and the success rate of the LDOB-PRM algorithm. The computational efficiency refers to the shortest time taken by an algorithm for a specific test model to achieve a success rate of 100%. For an identical test model, the success rate refers to a proportion of successful path searches to the total path searches (e.g., 10 path searches) using an algorithm in the case that the number of the sampling points is constant. Table 1 shows the test results.

TABLE 1

| | | PRM | | OB-PRM | | LDOB-PRM | |
|---|---|---|---|---|---|---|---|
| | | Success | | Success | | Success | |
| Test | | rate | Computation | rate | Computation | rate | Computation |
| examples | N | (%) | time (s) | (%) | time (s) | (%) | time (s) |
| Hole | 500 | 0 | \ | 80 | 14.04 | 100 | 13.87 |
| | 1000 | 60 | 11.98 | 100 | 49.29 | 100 | 45.32 |
| | 1500 | 80 | 26.59 | 100 | 68.27 | 100 | 59.23 |
| Cage | 500 | 0 | \ | 60 | 10.85 | 80 | 11.92 |
| | 1000 | 0 | \ | 100 | 42.86 | 100 | 48.70 |
| | 1500 | 70 | 26.73 | 100 | 66.64 | 100 | 64.43 |
| Narrow | 500 | 0 | \ | 70 | 20.50 | 80 | 14.84 |
| passage | 1000 | 60 | 13.75 | 100 | 84.86 | 100 | 85.15 |
| | 1500 | 80 | 37.79 | 100 | 108.72 | 100 | 106.18 |
| Square | 500 | 0 | \ | 80 | 18.45 | 90 | 18.22 |
| labyrinth | 1000 | 80 | 10.87 | 100 | 52.25 | 100 | 42.10 |
| | 1500 | 100 | 23.15 | 100 | 95.36 | 100 | 94.27 |

Taking a narrow passage as an example, a relationship between the success rate and the number of the sampling points is shown in FIG. 11. In FIG. 11, as compared with the basic PRM algorithm and the OB-PRM algorithm, it is able for the LDOB-PRM algorithm to achieve a larger success rate in the case of fewer sampling points. In Table 1, more collision detection needs to be performed so as to acquire the points at the surface of the obstacle. However, a success solution may still be achieved in the case that the number of the sampling points decreases, so the total computation time does not increase, i.e., it is able to improve the computational efficiency.

In addition, in order to make the method feasible, the present disclosure provides in some embodiments a prototype system for the automatic routing deign of the multi-branch cable. Table 2 shows indices and parameters of the system.

TABLE 2

| System indices | Parameters |
|---|---|
| Hardware | 2.80 GHz Intel Core Duo CPU E7400; Memory size: 2 G; |
| environment | Graphics Card: NVIDIA GT 630 |
| Operating | Windows XP SP3 |
| system | |
| Development | C++, XML, HTML |
| language | |
| Development | Microsoft Visual Studio 2005 |
| tool | |
| Design tool | SolidWorks, Pro/Engineer, UG NX |
| Support toolkit | Graphics Rendering Engine: HOOPS15; |
| | 3D Modeling tool: ACIS16 |

For the method for automatically routing the multi-branch cable in the embodiments of the present disclosure, example validation has been performed on a satellite structural plate, and product validation has been performed on a certain product with a complex structure. FIG. 12 shows a cable routing result, which meets the engineering constraint. In other words, the feasibility of the method in the embodiments of the present disclosure has been validated.

According to the method for automatically routing the multi-branch cable in the embodiments of the present disclosure, the position of the branch point is determined using the SMT algorithm, so as to ensure the shortest path of the multi-branch cable. In addition, through the LDOB-PRM algorithm, it is able to acquire the sampling points at the surface of obstacle, and then optimize the dispersion degree of the sampling points. As a result, it is able to meet the attaching-wall constraint for routing the multi-branch cable, and remarkably improve the computational efficiency and the success rate as compared with the basic PRM algorithm and the OB-PRM algorithm.

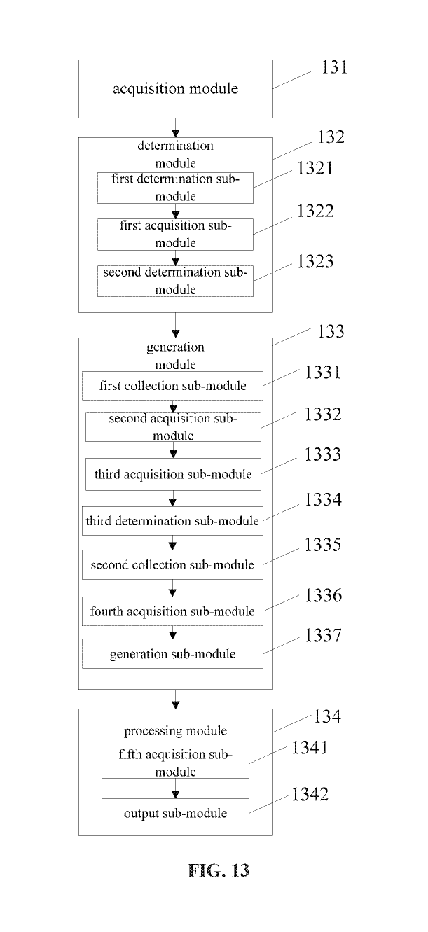

As shown in FIG. 13, the present disclosure further provides in some embodiments a device for automatically routing a multi-branch cable, including: an acquisition module 131 configured to acquire position information about connection terminals of the multi-branch cable in a solution space in accordance with a CAD model and a wiring table; a determination module 132 configured to determine position information about branch points of the multi-branch cable in the solution space in accordance with the position information about the connection thermals of the multi-branch cable and a first predetermined algorithm; a generation module 133 configured to generate a cable routing path map on the surfaces of obstacles in the solution space in accordance with the position information about the connection terminals of the multi-branch cable, the position information about the branch points and a second predetermined algorithm; and a processing module 134 configured to acquire and output a cable model as a routing design result in accordance with the cable routing path map.

In the embodiments of the present disclosure, the determination module 132 includes: a first determination sub-module 1321 configured to determine a Steiner point in accordance with the position information about the connection terminals of the multi-branch cable and an SMT algorithm, the Steiner point being such a point as to acquire a shortest connection path for all the connection terminals of the multi-branch cable; a first acquisition sub-module 1322 configured to acquire position information about a collision point at the surface of the obstacle closest to the Steiner point in the case that the Steiner point collides with the obstacle; and a second determination sub-module 1323 configured to determine a position of the branch point of the multi-branch cable in the solution space in accordance with the position information about the collision point at the surface of the obstacle.

In the embodiments of the present disclosure, the generation module 133 includes: a first collection sub-module 1331 configured to add the connection terminals of the multi-branch cable and the branch points as sampling points into a path map in accordance with the position information about the connection terminals of the multi-branch cable and the position information about the branch points; a second acquisition sub-module 1332 configured to acquire an initial sampling point in the solution space in accordance with a random sampling algorithm; a third acquisition sub-module 1333 configured to acquire position information about a collision point at the surface of the obstacle closest to the initial sampling point in the case that the initial sampling point collides with the obstacle; a third determination sub-module 1334 configured to determine a new sampling point at the surface of the obstacle in the solution space in accordance with the position information about the collision point at the surface of the obstacle; a second collection sub-module 1335 configured to add the new sampling point into the path map in accordance with a distance between the new sampling point and a point closest to the new sampling point in the path map; a fourth acquisition sub-module 1336 configured to acquire a neighboring node set of the new sampling point in the path map, the neighboring node set being a set of points within a predetermined range from the new sampling point in the path map; and a generation sub-module 1337 configured to connect the points in the neighboring node set to the new sampling point to acquire a plurality of edges, and adding the edges not interfering with others into the path map, so as to generate the cable routing path map on the surface of the obstacle in the solution space.

In the embodiments of the present disclosure, the second collection sub-module 1335 is configured to, in the case that the distance between the new sampling point and the point closest to the new sampling point in the path map is greater than a predetermined threshold, add the new sampling point into the path map.

In the embodiments of the present disclosure, the processing module 134 includes: a fifth acquisition sub-module 1341 configured to acquire a shortest path map between the connection terminals of the multi-branch cable and the branch points from the cable routing path map; and an output sub-module 1342 configured to fit the shortest path map to acquire and output the cable model as the routing design result.

According to the method and the device for automatically routing the multi-branch cable in the embodiments of the present disclosure, the position information about the connection terminals of the multi-branch cable in the solution space may be acquired in accordance with the CAD model and the wiring table. Next, the position information about the branch points of the multi-branch cable in the solution space may be determined in accordance with the position information about the connection terminals of the multi-branch cable and the first predetermined algorithm. Next, the cable routing path map on the surface of the obstacle in the solution space may be generated in accordance with the position information about the connection terminals of the multi-branch cable, the position information about the branch points and the second predetermined algorithm. Then, the cable model may be acquired and outputted as a routing design result in accordance with the cable routing path map. Through the generation of the cable routing path map on the surface of the obstacle in the solution space in accordance with the first predetermined algorithm and the second predetermined algorithm, it is able to meet the attaching-wall constraint for routing the multi-branch cable, and remarkably improve the computational efficiency and the success rate as compared with the conventional algorithms.

It should be appreciated that, the implementations of the device may refer to those of the method, so as to achieve an identical technical effect.

The above are merely the preferred embodiments of the present disclosure, but shall not be used to limit the present disclosure. A person skilled in the art may make any modifications, equivalent substitutions and improvements without departing from the spirit and principle of the present disclosure, which also fall within the scope of the present disclosure.

What is claimed is:

1. A method for automatically routing a multi-branch cable, comprising steps of:
acquiring position information about connection terminals of the multi-branch cable in a solution space in accordance with a Computer-Aided Design (CAD) model and a wiring table;
determining position information about branch points of the multi-branch cable in the solution space in accordance with the position information about the connection terminals of the multi-branch cable and a first predetermined algorithm;
generating a cable routing path map on a surface of an obstacle in the solution space in accordance with the position information about the connection terminals of the multi-branch cable, the position information about the branch points and a second predetermined algorithm; and
acquiring and outputting a cable model as a routing design result in accordance with the cable routing path map.

2. The method according to claim 1, wherein the step of determining the position information about the branch points of the multi-branch cable in the solution space in accordance with the position information about the connection terminals of the multi-branch cable and the first predetermined algorithm comprises:
acquiring a Steiner point in accordance with the position information about the connection terminals of the multi-branch cable and a Steiner Minimal Tree (SMT) algorithm, the Steiner point being such a point as to acquire a shortest connection path for all the connection terminals of the multi-branch cable;
acquiring position information about a collision point at the surface of the obstacle closest to the Steiner point in the case that the Steiner point collides with the obstacle; and
determining a position of the branch point of the multi-branch cable in the solution space in accordance with the position information about the collision point at the surface of the obstacle.

3. The method according to claim 1, wherein the step of generating the cable routing path map on the surface of the obstacle in the solution space in accordance with the position information about the connection terminals of the multi-branch cable, the position information about the branch points and the second predetermined algorithm comprises:
adding the connection terminals of the multi-branch cable and the branch points as sampling points into a path map in accordance with the position information about the connection terminals of the multi-branch cable and the position information about the branch points;
acquiring an initial sampling point in the solution space in accordance with a random sampling algorithm;
acquiring position information about a collision point at the surface of the obstacle closest to the initial sampling point in the case that the initial sampling point collides with the obstacle;
determining a new sampling point at the surface of the obstacle in the solution space in accordance with the position information about the collision point at the surface of the obstacle;
adding the new sampling point into the path map in accordance with a distance between the new sampling point and a point closest to the new sampling point in the path map;
acquiring a neighboring node set of the new sampling point in the path map, the neighboring node set being a set of points within a predetermined range from the new sampling point in the path map; and
connecting the points in the neighboring node set to the new sampling point to acquire a plurality of edges, and adding the edges not interfering with others into the path map, so as to generate the cable routing path map on the surface of the obstacle in the solution space.

4. The method according to claim 3, wherein the step of adding the new sampling point into the path map in accordance with the distance between the new sampling point and the point closest to the new sampling point in the path map comprises: in the case that the distance between the new sampling point and the point closest to the new sampling point in the path map is greater than a predetermined threshold, adding the new sampling point into the path map.

5. The method according to claim 1, wherein the step of acquiring and outputting the cable model as the routing design result in accordance with the cable routing path map comprises: acquiring a shortest path map between the connection terminals of the multi-branch cable and the branch points from the cable routing path map; and fitting the shortest path map to acquire and output the cable model as the routing design result.

6. A device for automatically routing a multi-branch cable, comprising:
an acquisition module configured to acquire position information about connection terminals of the multi-branch cable in a solution space in accordance with a Computer-Aided Design (CAD) model and a wiring table;
a determination module configured to determine position information about branch points of the multi-branch cable in the solution space in accordance with the position information about the connection terminals of the multi-branch cable and a first predetermined algorithm;
a generation module configured to generate a cable routing path map on a surface of an obstacle in the solution space in accordance with the position information about the connection terminals of the multi-branch cable, the position information about the branch points and a second predetermined algorithm; and
a processing module configured to acquire and output a cable model as a routing design result in accordance with the cable routing path map.

7. The device according to claim 6, wherein the determination module comprises:
a first determination sub-module configured to determine a Steiner point in accordance with the position information about the connection terminals of the multi-branch cable and a Steiner Minimal Tree (SMT) algorithm, the Steiner point being such a point as to acquire a shortest connection path for all the connection terminals of the multi-branch cable;
a first acquisition sub-module configured to acquire position information about a collision point at the surface of the obstacle closest to the Steiner point in the case that the Steiner point collides with the obstacle; and
a second determination sub-module configured to determine a position of the branch point of the multi-branch cable in the solution space in accordance with the position information about the collision point at the surface of the obstacle.

8. The device according to claim 6, wherein the generation module comprises:
a first collection sub-module configured to add the connection terminals of the multi-branch cable and the branch points as sampling points into a path map in accordance with the position information about the connection terminals of the multi-branch cable and the position information about the branch points;
a second acquisition sub-module configured to acquire an initial sampling point in the solution space in accordance with a random sampling algorithm;
a third acquisition sub-module configured to acquire position information about a collision point at the surface of the obstacle closest to the initial sampling point in the case that the initial sampling point collides with the obstacle;
a third determination sub-module configured to determine a new sampling point at the surface of the obstacle in the solution space in accordance with the position information about the collision point at the surface of the obstacle;
a second collection sub-module configured to add the new sampling point into the path map in accordance with a distance between the new sampling point and a point closest to the new sampling point in the path map;
a fourth acquisition sub-module configured to acquire a neighboring node set of the new sampling point in the path map, the neighboring node set being a set of points within a predetermined range from the new sampling point in the path map; and
a generation sub-module configured to connect the points in the neighboring node set to the new sampling point to acquire a plurality of edges, and adding the edges not interfering with others into the path map, so as to generate the cable routing path map on the surface of the obstacle in the solution space.

9. The device according to claim 8, wherein the second collection sub-module is configured to, in the case that the distance between the new sampling point and the point closest to the new sampling point in the path map is greater than a predetermined threshold, add the new sampling point into the path map.

10. The device according to claim 6, wherein the processing module comprises: a fifth acquisition sub-module configured to acquire a shortest path map between the connection terminals of the multi-branch cable and the branch points from the cable routing path map; and an output sub-module configured to fit the shortest path map to acquire and output the cable model as the routing design result.
